(19) United States
(12) Patent Application Publication
(10) Pub. No.: US 2010/0049421 A1
(43) Pub. Date: Feb. 25, 2010

(54) CONTROL DEVICE FOR INTERNAL COMBUSTION ENGINE, AND CONTROL METHOD THEREFOR

(76) Inventors: Yoshinori Futonagane, Shizuoka-ken (JP); Fumihiro Okumura, Shizuoka-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/444,178

(22) PCT Filed: Mar. 19, 2008
(86) PCT No.: PCT/IB2008/000657

§ 371 Date: Apr. 3, 2009

(30) Foreign Application Priority Data
Mar. 20, 2007 (JP) 2007-071733

(51) Int. Cl. F02D 41/30; F02B 43/00; F02D 41/00

(52) U.S. Cl. 701/103; 123/1 A; 123/703

(57) ABSTRACT

A control device (engine control device 5) for an internal combustion engine (2) includes a carbon particulate matter amount output portion (smoke sensor 53) that produces an output that indicates the floating carbon particulate matter amount, and an accumulation amount output portion (CPU 51a) that produces an output that indicates the accumulation amount of an extraneous matter (deposit) in and around injection orifices (second injection orifices 31c) based on the output value of the floating carbon particulate matter amount.

### BACKGROUND OF THE INVENTION

1. Field of the Invention

The invention relates to a control device for an internal combustion engine equipped with a fuel injection device that is constructed so as to inject fuel from injection orifice into a combustion chamber, and a control method for the internal combustion engine.

2. Description of the Related Art

Japanese Patent Application Publication No. 2002-310042 (JP-A-2002-310042) and Japanese Patent Application Publication No. 2006-57538 (JP-A-2006-57538) describe internal combustion engine control devices. The control devices estimate the state of an extraneous matter (deposit) that attaches/accumulates in and around injection orifice of the fuel injection device (injector), and perform a process based on a result of the estimation.

In the device described in JP-A-2002-310042, the nozzle of the injector is provided with first injection orifices and second injection orifices. Under certain operation conditions, fuel may be injected from both the first injection orifices and the second injection orifices and under other conditions, the fuel may be injected only from the first injection orifices while no fuel is injected from the second injection orifices.

If in this construction, the fuel injection from the second injection orifice is not performed at all for a relatively long period of time, deposits may accumulate in and around the outlet opening of each second injection orifices. The accumulation of deposits may disrupt to the amount of fuel injected via the second injection orifices. Therefore, if the operation condition in which the injection via the second injection orifices is not performed continues for a predetermined period, fuel injection is compulsorily performed via the second injection orifices.

The device described in JP-A-2006-57538 is designed to calculate an instantaneous index that indicates the amount of accumulated deposits, based on the temperature of the distal end of the injector and the concentration of nitrogen oxides, and then estimate the amount of deposits that has accumulated around the injection orifice by integrating the instantaneous values.

### SUMMARY OF THE INVENTION

The invention provides a control device for an internal combustion engine (hereinafter, simply referred to as “control device”) that more appropriately executes an operation control of the internal combustion engine by accurately determining the amount of deposits in and around the injection orifices, and also provides a control method for the internal combustion engine.

In a first aspect of the invention, a control device controls an operation of an internal combustion engine equipped with a fuel injection device. The fuel injection device includes injection orifices, injects fuel into the combustion chamber. The fuel injection device is disposed so that the injection orifices are exposed to the combustion chamber. That is, the fuel injection device is constructed and disposed so that fuel is injected directly into the combustion chamber via the injection orifices.

In the first aspect of the invention, the control device includes a carbon particulate matter amount output portion, and an accumulation amount output portion. The carbon particulate matter amount output portion produces an output (voltage, current, or numerical data representing the floating carbon particulate matter amount) that indicates the amount of floating carbon particulate matters in the post-combustion gas discharged from the combustion chamber into the exhaust passageway. The accumulation amount output portion produces an output that indicates the amount of extraneous matter that has accumulated in and around the injection orifices based on the output of the carbon particulate matter amount output portion.

Occasionally, during the operation of the internal combustion engine, unburned fuel remains inside the injection orifices or unburned fuel may adhere to a portion of the fuel injection device near the injection orifices. A product formed by the unburned fuel undergoing a reaction, such as incomplete combustion or the like, or an impurity precipitated by the volatilization of the unburned fuel sometimes adheres to the inside of the injection orifices or in the vicinity thereof.

Furthermore, the vicinity of the injection orifices is exposed to the post-combustion gas that is generated in the combustion chamber. At this time, the carbon particulate matter (the aforementioned floating carbon particulate matter) generated at the time of combustion of fuel in the combustion chamber sometimes attaches to the inside of the injection orifices or the vicinity thereof.

In this manner, the extraneous matter that accumulates on the inside or in the vicinity of the injection orifices. Incidentally, the extraneous matter mainly includes carbon and carbon-based compounds. In particular, the floating carbon particulate matter can be a material that constitutes the extraneous matter. Therefore, the floating carbon particulate matter amount can greatly affect the amount of accumulated particulate matter (substantially, the floating carbon particulate matter amount may be considered a direct factor of the accumulation amount of the extraneous matter).

In this respect, in the first aspect, the output that indicates the accumulation amount of the extraneous matter is obtained based on the output that indicates the floating carbon particulate matter amount. That is, in the invention, the accumulation amount is determined based on the floating carbon particulate matter amount. In addition, the determination of the accumulation amount may be performed at predetermined intervals (e.g., every operation cycle of the internal combustion engine, or at predetermined times).

According to the first aspect, the state of the accumulated extraneous matter is more accurately determined based on the floating carbon particulate matter amount. Therefore, according to the first aspect, operation controls of the internal combustion engine (a correction control of the fuel injection amount, a compulsory fuel injection control for removing the extraneous matter, etc.) may be more appropriately performed.

The carbon particulate matter amount output portion may be provided with a floating carbon particulate matter amount sensor. The floating carbon particulate matter amount sensor is provided on the exhaust passageway. The floating carbon particulate matter amount sensor is constructed, for example, to output a voltage that is in accordance with the floating carbon particulate matter amount, or numerical data that is obtained by converting the voltage into a digital signal.

The carbon particulate matter amount output portion may be provided with a floating carbon particulate matter amount estimation portion. The floating carbon particulate matter amount estimation portion outputs an estimated value of the floating carbon particulate matter amount based on an operation condition of the internal combustion engine. The operation condition herein is a parameter that controls the internal combustion engine and its peripheral devices in order to realize a predetermined operation state, such as a target engine rotation speed, a target load, a requested (or commanded) fuel injection amount, etc.

The floating carbon particulate matter amount estimation portion may output an estimated floating carbon particulate matter amount based on a signal (a waveform of current or voltage, or numerical data) that indicates the fuel injection amount of the internal combustion engine and a signal (a waveform of current or voltage, or numerical data) that indicates the engine rotation speed.

If the exhaust passageway is provided with a filter, a first pressure sensor and a second pressure sensor, the floating carbon particulate matter amount estimation portion may output an estimated value of the floating carbon particle amount based on the output of the first pressure sensor and the output of the second pressure sensor.

The filter traps floating carbon particles. In addition, the first pressure sensor is provided upstream from the filter and the second pressure sensor is provided downstream from the filter. The first and second pressure sensors each produce an output that is in accordance with the pressure of the gas.

The control device may further include a correction portion. The correction portion corrects the output of the estimated value based on the present intake air amount.

The carbon particle amount output portion may produce a plurality of outputs that indicate the floating carbon particulate matter amount.

In this case, the accumulation amount output portion may output the amount of accumulated particulate matter based on the output from the carbon particle amount output portion that gives the largest value of the floating carbon particle amount.

In such a construction, for example, the accumulation amount output portion obtains a plurality of inputs from the carbon particle amount output portion, and produces an output based on the input that gives the largest value of the floating carbon particulate matter amount. Alternatively, of the plurality of outputs of the carbon particulate matter amount output portion, the output that gives the largest floating carbon particulate matter amount is input to the accumulation amount output portion. Based on the input, the accumulation amount output portion produces an output that indicates to the accumulated amount.

According to this construction, the control of the internal combustion engine is more appropriately performed. For example, the compulsory fuel injection control for reducing the occurrence of extensive accumulation of the particulate matter, such that the injection orifices is completely obstructed by the extraneous matter, may be performed at more appropriate timing.

Alternatively, if the carbon particulate matter amount output portion is constructed as described above, the accumulation amount output portion may produce an output based on the accumulation amount obtained based on the plurality of outputs of the carbon particulate matter amount output portion that gives the largest value of the accumulation amount among the plurality of values.

In this construction, the accumulation amount output portion obtains a plurality of values that indicate the accumulation amount based on a plurality of outputs of the carbon particulate matter amount output portion. Then, the accumulation amount output portion produces an output based on the value that gives the largest value of the accumulation amount.

According to this construction, the control of the internal combustion engine may more appropriately be performed, as described above.

Incidentally, the temperature of the fuel injection device in the vicinity of the injection orifices is an important factor of the generation/accumulation of the extraneous matter. Therefore, the accumulation amount output portion may produce an output based on the temperature of the vicinity of the injection orifices. This makes it possible to more accurately acquire or estimate the state of the accumulation of the extraneous matter.

Incidentally, if a high-temperature state in which the temperature is at or above a predetermined level continues for a long time, abrasion of the aforementioned portion will progress, or the extraneous matter will become chemically bonded to the aforementioned portion. Therefore, the control device may perform a control to change the operation state to one in which the temperature decreases, if the high-temperature state in which the temperature is at or above a predetermined level continues for a predetermined time. This makes it possible to more favorably perform the fuel injection control of the fuel injection device.

If the fuel injection device has a first injection orifice and a second injection orifice, and can selectively carries out a first fuel injection mode, in which fuel is injected through only the first injection orifices, and a second fuel injection mode, in which fuel is injected through both the first and second injection orifices, the accumulation amount output portion may produce an output that indicates the accumulation amount of the extraneous matter in and around the second injection orifices.

In this construction of the fuel injection device, if the first fuel injection mode continues for some time, the accumulation of the extraneous matter in and around the second injection orifices will become likely. In the first aspect, from the output of the accumulation amount output portion, the amount of accumulated extraneous matter in an around the second injection orifices is determined. Therefore, the fuel injection control in the internal combustion engine that includes a variable injection orifice nozzle type fuel injection device may be more appropriately performed.

As described above, the first aspect of the invention is applicable to various instances in operation controls of the internal combustion engine. Therefore, for example, the control device may perform compulsory injection of fuel in order to remove the extraneous matter, in accordance with the output of the accumulation amount output portion. Alternatively, the control device may perform correction of the fuel injection amount (obtain a correction amount for obtaining a commanded fuel injection amount by correcting a requested fuel injection amount) in accordance with the output of the accumulation amount output portion.

A second aspect of the invention is drawn to a control method for an internal combustion engine that includes a fuel injection device that injects fuel from an injection orifice into a combustion chamber. The control method includes: producing an output that indicates the floating carbon particulate matter amount in a post-combustion gas discharged into an exhaust passageway; and producing an output that indicates the accumulation amount of an extraneous matter in and around the injection orifices based on the output that indicates the floating carbon particle amount.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a schematic diagram showing a general construction of embodiments of the invention;

FIG. 2A is an enlarged side sectional view of a distal end portion of a nozzle as shown in FIG. 1;

FIG. 2B is an enlarged side sectional view of the distal end portion of the nozzle as shown in FIG. 1;

FIG. 2C is an enlarged side sectional view of the distal end portion of the nozzle as shown in FIG. 1;

FIG. 3 is a graph of results of experiments showing the influence of the amount of particulate matter on the degree of obstruction of second injection orifices;

FIG. 4 is a flowchart of an example operation of estimating the amount of accumulated particulate matter in an embodiment of the invention;

FIG. 5 is a flowchart of the operation of a nozzle temperature adjustment process; and

FIG. 6 shows an example of a soot map.

### DETAILED DESCRIPTION OF EMBODIMENTS

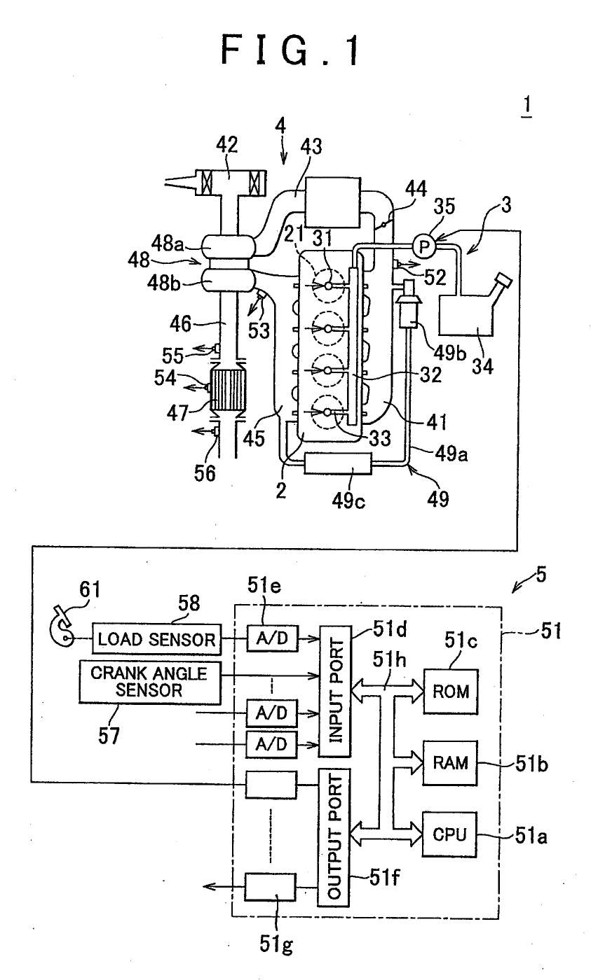

Embodiments of the invention will be described hereinafter with reference to the drawings.

<GENERATION CONSTRUCTION OF SYSTEM> FIG. 1 is a schematic diagram showing a general construction of an embodiment of the invention. Referring to FIG. 1, an engine control system 1 includes an engine 2, a fuel injection device 3, an intake/exhaust device 4, and an engine control device 5. In the engine 2 of this embodiment, a plurality of combustion chambers 21 are provided.

<<FUEL INJECTION DEVICE>> The fuel injection device 3 includes a plurality of nozzles 31. The nozzles 31 in this embodiment are well-known piezo-type fuel injection nozzles. One nozzle 31 is disposed in each of the combustion chambers 21.

Each nozzle 31 is provided so that its distal end is exposed to its corresponding combustion chamber 21. That is, the fuel injection device 3 is constructed so that fuel is injected from the distal end of each nozzle 31 that is exposed to its corresponding combustion chamber 21 directly into the combustion chamber 21.

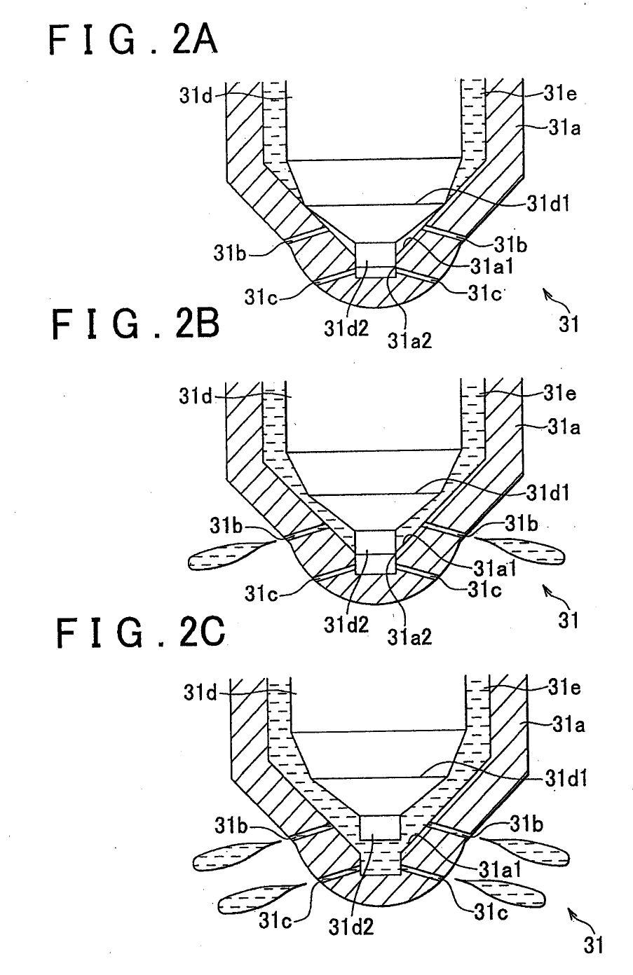

FIGS. 2A to 2C are enlarged side sectional views of the distal end portion of each nozzle 31 shown in FIG. 1. Referring to FIG. 2A, a housing 31a that constitutes a main body portion of a nozzle 31 is constructed of a tubular member whose distal end portion is closed. The closed distal end portion thereof is formed in a generally inverted cone shape. The distal end portion of the housing 31a is provided with a first seat portion 31a1 and a second seat portion 31a2.

The first seat portion 31a1 is formed by an inner surface of a truncated conical depression. A distal end of the first seat portion 31a1 (a lower end thereof) is connected to the second seat portion 31a2. The second seat portion 31a2 is formed by a generally cylindrical internal surface, and a distal end thereof (a lower end thereof) of the second seat portion 31a2 is closed by a most distal end portion of the housing 31a. The first seat portion 31a1 and the second seat portion 31a2 are provided to form a depression that opens toward the interior of the housing 31a.

First injection orifices 31b and second injection orifices 31c are formed in the distal end portion of the housing 31a. The first injection orifices 31b and the second injection orifices 31c are formed as penetration holes that can connect the distal end portion of the space inside the housing 31a and the space outside the housing 31a in communication with each other. In this embodiment, the second injection orifices 31c are provided at a position closer to the distal end (toward the lower end in the drawings) of the housing 31a than the first injection orifices 31b are.

In this embodiment, the first injection orifices 31b are located closer to the distal end (closer to the lower end in the drawings) of the first seat portion 31a1. In addition, in this embodiment, a plurality of first injection orifices 31b are formed so as to be radial, in a plan view, from a center axis of the housing 31a that extends along the up-down direction in the drawings, and so as to be at equal angles with respect to the center axis.

The second injection orifices 31c are provided at positions that correspond to a lower end portion of the second seat portion 31a2. That is, the second injection orifices 31c are provided in the most distal end portion of the housing 31a. The second injection orifices 31c in this embodiment are radially and equiangularly formed, similarly to the first injection orifices 31b.

Inside the housing 31a, a needle valve 31d is housed so as to be movable in the axial direction (the up-down direction in the drawings). The needle valve 31d is constructed of a thin elongated rod-like member. The distal end portion of the needle valve 31d is formed in a shape that is obtained by joining a first inverted frustum whose cone angle is large, a second inverted frustum whose cone angle is small, and a cylinder in that order.

In the distal end portion of the needle valve 31d, a first seat contact portion 31d1 is provided at a position at which the first inverted frustum and the second inverted frustum interconnect. The first seat contact portion 31d1 is a circular edge portion that is formed protruding outward. The entire perimeter of the first seat contact portion 31d1 is formed so as to be able to join liquid-tightly with the first seat portion 31a1.

That is, the first seat contact portion 31d1 is formed so as to shut off the communication of the first injection orifices 31b and the second injection orifices 31c with a fuel passageway 31e (a space between a portion of the housing 31a that is on the upstream side of the generally inserted cone-shape distal end portion of the housing 31a in the fuel supply direction and a portion of the needle valve 31d that is on the upstream side of the first seat contact portion 31d1).

The most distal end portion of the needle valve 31d is provided with a second injection orifice closure portion 31d2. The second injection orifice closure portion 31d2 is the aforementioned cylindrical portion in the distal end portion of the needle valve 31d, and is constructed so as to be able to shut off the communication between a generally tubular recess formed by the second seat portion 31a2 and the second injection orifices 31c by sinking and fitting into the tubular recess.

The nozzle 31 in this embodiment is able to assume a state (see FIG. 2B) in which the first injection orifices 31b and the fuel passageway 31e communicate with each other but the communication between the second injection orifices 31c and the fuel passageway 31e is shut off, and a state (see FIG. 2C) in which both the first injection orifices 31b and the second injection orifices 31c communicate with the fuel passageway 31e, in accordance with the state of lift (amount of lift) of the needle valve 31d.

That is, in this embodiment, the nozzle 31 is constructed so that a first fuel injection mode (see FIG. 2B), in which fuel is injected through only the first injection orifices 31b, and a second fuel injection mode (see FIG. 2C), in which fuel is injected through both the first injection orifices 31b and the second injection orifices 31c, may be selectively used in accordance with the operation condition, such as the load, the amount of fuel injection, etc.

Referring to FIG. 1, the fuel injection device 3 is a conventional common-rail type fuel injection device in which the nozzles 31 are connected to a common rail 32 via fuel supply pipes 33. In addition, a fuel pump 35 is installed on a fuel supply passageway between the common rail 32 and the fuel tank 34.

<<INTAKE/EXHAUST DEVICE>> The intake/exhaust device 4 is constructed as described below so as to be able to supply air (including recirculated exhaust gas) to the combustion chambers 21 of the engine body 2, discharge exhaust gas from the combustion chambers 21, and purify the exhaust gas.

An intake manifold 41 is attached to the engine body 2 so as to be able to supply air to each combustion chamber 21. The intake manifold 41 is connected to an air cleaner 42 via an intake pipe 43. A throttle valve 44 is installed in the intake pipe 43.

An exhaust manifold 45 constituting an exhaust passageway in this embodiment is attached to the engine body 2 so as to be able to receive exhaust gas from each combustion chamber 21. The exhaust manifold 45 is connected to the exhaust pipe 46. A catalyst filter 47 is installed in the exhaust pipe 46 constituting an exhaust passageway in the embodiment.

The catalyst filter 47 in this embodiment is constructed so as to remove three components in exhaust gas, that is, HC, CO and NOx, and so as to have a function of a particle filter of trapping floating carbon particle in exhaust gas (hereinafter, simply referred to as “particle”). Furthermore, the catalyst filter 47 is constructed so as to be restorable, that is, have a restoration function of oxidizing the trapped particle into carbon dioxide upon receiving high-temperature exhaust gas.

A turbocharger 48 is installed between the intake pipe 43 and the exhaust pipe 46. Specifically, the intake pipe 43 is connected to a side of a compressor 48a of the turbocharger 48, and the exhaust pipe 46 is connected to a side of a turbine 48b of the turbocharger 48.

An EGR device 49 is installed between the intake manifold 41 and the exhaust manifold 45. The “EGR” herein is an abbreviation of “Exhaust Gas Recirculation”. The EGR device 49 includes an EGR passageway 49a, a control valve 49b, and an EGR cooler 49c.

The EGR passageway 49a is a passageway of EGR gas (re-circulated exhaust gas), connects the intake manifold 41 with the exhaust manifold 45. The control valve 49b and the EGR cooler 49c are installed in the EGR passageway 49a. The control valve 49b controls the amount of EGR gas that is supplied to the intake manifold 41. The EGR cooler 49c cools the EGR gas using engine coolant.

<<ENGINE CONTROL DEVICE>> The engine control device 5 in this embodiment includes an electronic control unit (ECU) 51. The ECU 51 includes a CPU (microprocessor) 51a, a RAM (random access memory) 51b, a ROM (read-only memory) 51c, an input port 51d, A/D converters 51e, an output port 51f, drivers 51g, and a bidirectional bus 51h.

The CPU 51a, which functions as an accumulation amount output portion in this embodiment, executes routines (programs) to control operations of various portions of the engine control system 1. Data is temporarily stored in the RAM 51b in accordance with need, at the time of execution of a routine by the CPU 51a. The ROM 51c pre-stores the above described routines (programs), tables (lookup tables, maps) that are referred to when executing the routines, referring to the parameters, etc.

The input port 51d are connected to various sensors (described below) of the engine control system 1, via A/D converters 51e. The output port 51f is connected to various portions (the nozzles 31, and the like) of the engine control system 1 via drivers 51g. The CPU 51a, the RAM 51b, the ROM 51c, the input port 51d, and the output port 51f are interconnected via the bidirectional bus 51h.

Various sensors are connected to the input port 51d of the ECU 51, including an air flow meter 52, a smoke sensor 53, a catalyst temperature sensor 54, an upstream-side pressure sensor 55, a downstream-side pressure sensor 56, a crank angle sensor 57, and a load sensor 58, via respective A/D converters 51e.

The air flow meter 52 produces an output voltage according to the mass flow per unit time of intake air flowing in the intake pipe 43.

The soot sensor 53 as a carbon particle amount output portion (floating carbon particle amount sensor) in this embodiment is installed in the exhaust manifold 45. The soot sensor 53 produces an output voltage that indicates the amount of soot in the post-combustion exhaust gas discharged into the exhaust manifold 45.

The catalyst temperature sensor 54 is constructed so as to produce an output voltage according to the temperature of the catalyst filter 47.

The upstream pressure sensor 55 functions as a first pressure sensor in this embodiment and is provided upstream from the catalyst filter 47. The downstream pressure sensor 56 functions as a second pressure sensor in this embodiment and is provided downstream from the catalyst filter 47. The upstream pressure sensor 55 and the downstream pressure sensor 56 each provide an output according to the pressure of exhaust gas.

The crank angle sensor 57 outputs a narrow-width pulse every time the crankshaft (not shown) of the engine 2 rotates through a predetermined angle (e.g., 10°), and outputs a wide-width pulse every time the crankshaft turns through 360°. From the output of the crank angle sensor 57, the engine rotation speed may be determined.

The load sensor 58 is an accelerator operation amount sensor, and produces an output voltage according to the amount of operation (amount of depression) of an accelerator pedal 61.

<OVERVIEW OF DEPOSIT ATTACHMENT STATE ESTIMATION IN EMBODIMENT> An overview of means for estimating the state of accumulated particulate matter (the instantaneous amount of deposit, and the accumulation amount of deposit) will be described with reference to the drawings.

In the fuel injection device 3, the first fuel injection mode (see FIG. 2B), in which fuel is injected only via the first injection orifices 31b, and the second fuel injection mode (see FIG. 2C) in which fuel is injected via both the first injection orifices 31b and the second injection orifices 31c, are selectively carried out according to the operation condition. That is, in this embodiment, the second injection orifices 31c are used less frequently than the first injection orifices 31b.

Therefore, after the first fuel injection mode, that is, the state in which the injection of fuel from the second injection orifices 31c is not performed, has been in operation for some time, particulate matter may accumulate on the in and around the second injection orifices 31c.

In the embodiment, the instantaneous accumulation amount of particulate matter and the accumulation amount of particulate matter in and around the second injection orifices 31c are estimated in the following manner.

The accumulation of particulate matter in and around the second injection orifices 31c is considered to occur by the following mechanism. (1) In the case of the first fuel injection mode, fuel remains in second injection orifices 31c and in the generally tubular depressions formed by the second seat portion 31a2. In addition, a portion of the fuel injected from the first injection orifices 31b adheres to the periphery of the outside opening portions of the second injection orifices 31c (i.e., the opening portions facing the combustion chamber 21). The products of reactions, such as incomplete combustion of unburned fuel or the like, and the impurities precipitated by the volatilization of the unburned fuel form the accumulated particulate matter. (2) Portions adjacent to the second injection orifices 31c are exposed to post-combustion gas produced in the combustion chamber 21. At this time, the particulate matter produced at the time of combustion of fuel in each combustion chamber 21 adheres to the insides of the second injection orifices 31c and the vicinity of the second injection orifices 31c.

The region of operation in which the first fuel injection mode, in which the injection of fuel from the second injection orifices 31c is not performed, is carried out is an operation region of relatively low load. In such an operation region, the temperature of the adjacent portions of the second injection orifices 31c is relatively low.

When the engine operates under a low load, particulate matter “physically” adheres to the inside and vicinity of the second injection orifices 31c (a chemical bond is not formed between deposit and the housing 31a). In this case, the amount of particulate matter accumulated in and around the second injection orifices 31c may be effectively reduced by the fuel injection from the second injection orifices 31c.

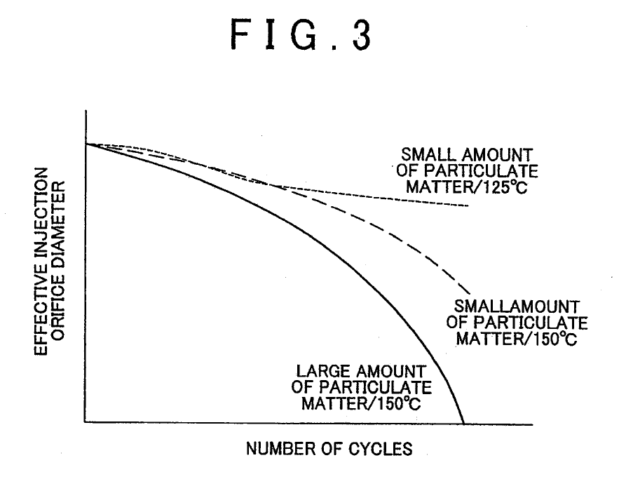

FIG. 3 is a graph of results of experiments showing the influence of the amount of accumulated particulate matter on the degree of obstruction of the second injection orifices 31c. In FIG. 3, the horizontal axis represents the number of cycles, and the vertical axis represents the effective injection orifices diameter that is found from the injection pressure and the actual injection amount. The temperature shown in the diagram is the nozzle temperature. As is apparent from FIG. 3, when the load on the engine is relatively low and the nozzle temperature (the temperature in the vicinity of the second injection orifices 31c) is low, the degree of obstruction of the second injection orifices 31c (the degree of decrease in the effective injection orifices diameter) due to the amount particulate matter, may be large. In addition, the degree of obstruction of the second injection orifices 31c is also affected by temperature.

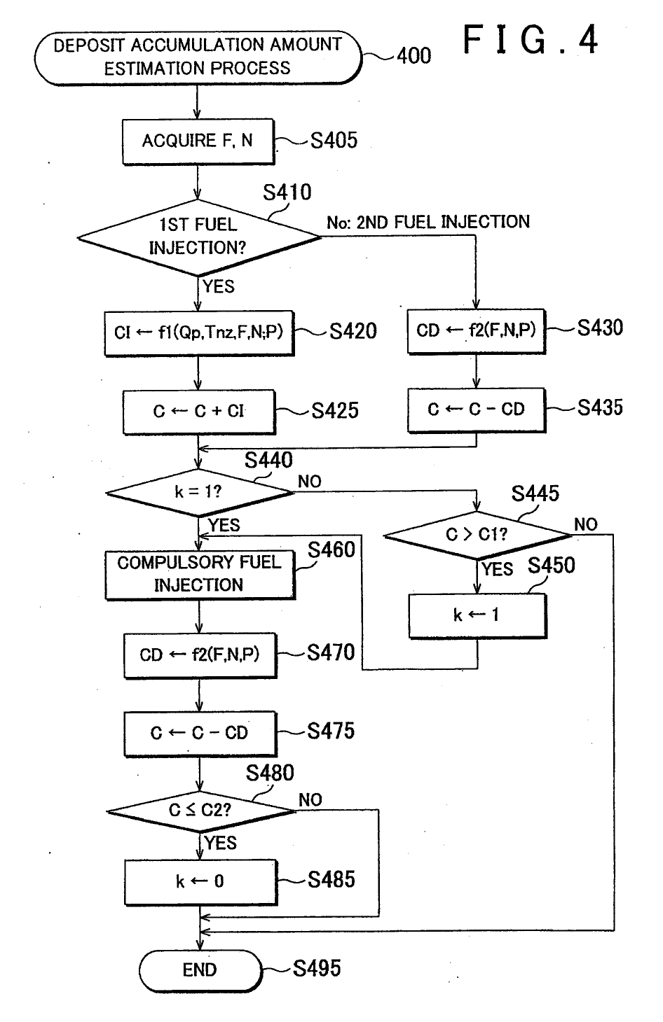

Therefore, the instantaneous accumulation amount of particulate matter in a given cycle may be expressed as a function of the amount of particulate matter Qp and the nozzle temperature Tnz. Furthermore, the accumulation amount of particulate matter increases as the number of operation cycles increases the longer that fuel is not injected from the second injection orifices. Therefore, the accumulation amount of particulate matter may be estimated by integrating the instantaneous accumulation amounts as the operation cycles in the first fuel injection are executed.

<CONCRETE EXAMPLES OF ESTIMATION OF DEPOSIT ATTACHMENT STATE IN EMBODIMENT> Next, a example of an operation of estimating the amount of accumulated particulate matter will be described with reference to FIG. 4.

FIG. 4 is a flowchart that depicts the above operation. In the description of each step (hereinafter, the “step” is abbreviated as “S”), reference characters used in FIGS. 1, 2A, 2B and 2C are appropriately used.

The CPU 51a in the ECU 51 execute the particulate matter accumulation amount estimation process 400 shown in FIG. 4 at predetermined intervals (e.g., crank angle).

When the deposit accumulation amount estimation process routine 400 is executed, the fuel injection amount F in the present operation and the requested engine rotation speed N are acquired based on the output of the load sensor 58 and the like in S405. In this example, it is assumed that the requested fuel injection amount is used as the fuel injection amount F in the present operation. The requested fuel injection amount is a pre-feedback-correction fuel injection amount obtained based on the cylinder intake air amount Mc obtained based on the intake air flow amount Ga based on the output of the air flow meter 52, the present engine rotation speed Ne and a predetermined map, and a requested engine rotation speed N based on the output of the load sensor 58, as well as a target air-fuel ratio.

Next, in S410, based on the fuel injection amount F in the present operation, the requested engine rotation speed N and the present fuel injection pressure P, it is determined whether the fuel injection device 3 is operating in the first fuel injection mode or the second fuel injection mode.

If the fuel injection device 3 is operating in the first fuel injection mode (S410=Yes), an increment amount CI of a counter C for integrating the particulate matter amount is acquired in S420, and the counter C is accordingly incremented in S425. The increment amount CI is acquired from a map based on the amounts Qp, Tnz, F, N and P (or based on the output signals of the sensors that correspond to these physical quantities, which applies in the same manner in the following description as well).

In this example, it is assumed that in the acquisition of the increment amount CI, the amount Qp acquired based on the output signal of the smoke sensor 53 is used. In addition, in this example, it is assumed that the nozzle temperature Tnz is found from a map based on the amounts N, F and P and the ignition timing. The ignition timing may be obtained by the detection using a combustion pressure sensor, or by the estimation using an ignition model. For the estimation by the ignition model, at least one or more of the parameters, including the amounts Ga, Ne, F and P, the intake pipe temperature, the engine coolant temperature, the injection timing, the EGR rate, the supercharge pressure, etc., can be used.

If the fuel injection device 3 is operating in the second fuel injection mode (S410=No), a decrement amount CD of the particulate matter amount counter C is acquired in S430, and the counter C is accordingly decremented in S435. The decrement amount CD is acquired from a map based on the amounts F, N and P.

After the counter C is incremented or decremented based on the result of the determination in S410, it is determined in S440 whether a compulsory fuel injection implementation flag k is set (is “1” or “0”).

If the compulsory fuel injection implementation flag is not set (S440=No), it is determined in S445 whether the counter C is greater than a predetermined value C1. If the counter C is larger than a predetermined value C1 (limit particulate matter amount) (S445=Yes), the compulsory fuel injection implementation flag k is set in S450. If the counter C is less than the predetermined value C1 (S445=No), the steps that follow are skipped.

If the compulsory fuel injection implementation flag k has been set (S440=Yes), or if the compulsory fuel injection implementation flag k is set in S450, fuel is compulsorily injected through the second injection orifices 31c in S460. After that, in S470, the decrement amount CD of the particulate amount counter C is acquired based on the condition of the compulsory fuel injection in the present operation, similarly to S430. Then in S475, the counter C is decremented.

Subsequently in S480, it is determined whether the post-compulsory-fuel-injection counter C is less than or equal to a predetermined value C2 (permissible particulate matter amount). If the counter C is less than or equal to the predetermined value C2 (S480=Yes), the compulsory fuel injection implementation flag k is reset in S485 (set to “0”). However, if the counter C is greater than the predetermined value C2 (S480=No), S485 is skipped.

After the compulsory fuel injection implementation flag k and the counter C for integrating the particulate matter amount and the compulsory fuel injection based on the values of the flag k and the counter C are performed, the process proceeds to S495, in which this routine is ended.

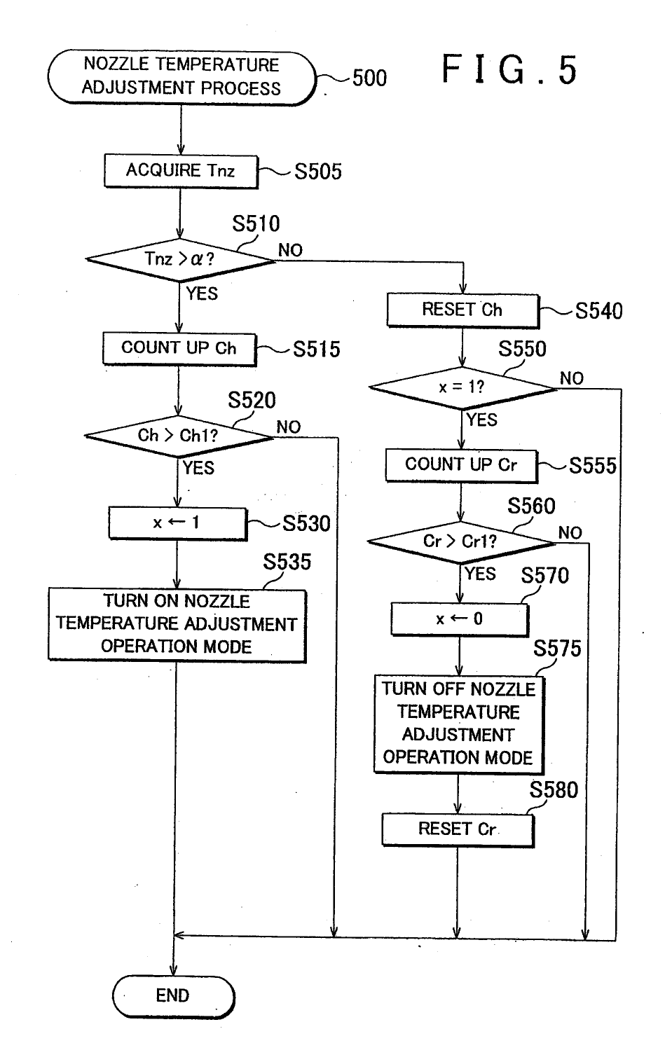

In the process according to the above example, the instantaneous attachment amount of particulate matter and the accumulation amount of particulate matter in and around the second injection orifices 31c is more accurately determined based on the amount of particulate matter. The use of such a determined value allows more appropriate performance of the compulsory fuel injection control for clearing the particulate matter from in and around the second injection orifices 31c.

<CONCRETE EXAMPLE OF NOZZLE TEMPERATURE ADJUSTMENT> Next, an example of a nozzle temperature adjustment process for reducing the chemical bonding of particulate matter to the distal end portion of the nozzle 31 and the progress of abrasion of the distal end portion of the nozzle 31 will be described with reference to FIG. 5.

FIG. 5 is a flowchart that describes the foregoing operation.

The CPU 51a in the ECU 51 executes a nozzle temperature adjustment process routine 500 shown in FIG. 5 at predetermined intervals (e.g., crank angle).

When the nozzle temperature adjustment process routine 500 is executed, the nozzle temperature Tnz is initially acquired in S505. The nozzle temperature Tnz is acquired as described above. Next in S510, it is determined whether the nozzle temperature Tnz is above a predetermined temperature α° C. (e.g., 170° C.).

If the nozzle temperature Tnz is above the predetermined temperature α° C. (S510=Yes), the process proceeds to S515, in which the incrementing of a counter Ch for measuring the duration of a state in which the nozzle temperature is high is started. Subsequently in S520, it is determined whether the value of the counter Ch exceeds a predetermined value Ch1. If the value of the counter Ch exceeds the predetermined value Ch1 (S520=Yes), the process proceeds to S530, in which a nozzle temperature adjustment mode flag x is set. Then in S535, the engine operation condition is set to a nozzle temperature adjustment mode for reducing the nozzle temperature. The nozzle temperature adjustment mode may be implemented by adjusting at least one or more of the amounts Ga, F and P, the injection timing, the supercharge pressure, etc. (decreasing the amounts E, P, or increasing the amount Ga, etc.). If the value of the counter Ch is not above the predetermined value Ch1 (S520=No), S530 and the steps that follow are skipped.

If the nozzle temperature Tnz is below the predetermined temperature α° C. (S510=No), the counter Ch is reset in S540. Next, in S550, it is determined whether the nozzle temperature adjustment mode flag x has been set. If the nozzle temperature adjustment mode flag x has not been set (S550=No), S555 and the steps that follow are skipped.

If the nozzle temperature adjustment mode flag x is set (S550=Yes), the process proceeds to S555, in which the incrementing of a counter Cr for measuring the duration of the nozzle temperature adjustment mode is started. Subsequently in S560, it is determined whether the value of the counter Cr exceeds a predetermined value Cr1.

If the value of the counter Cr exceeds the predetermined value Cr1 (S560=Yes), the nozzle temperature adjustment mode flag x is reset in S570. Then, the nozzle temperature adjustment mode is canceled in S575, and the counter Cr is reset in S580. If the value of the counter Cr does not exceed the predetermined value Cr1 (S560=No), S570 and the steps that follow are skipped.

After that, the process proceeds to S595 and the routine ends.

According to the process of this example, the prolonged continuation of an operation state in which the nozzle temperature exceeds the predetermined temperature α° C. is effectively reduced. Therefore, the chemical bonding of the particulate matter to the distal end of the nozzle 31 and the progress of abrasion of the distal end of the nozzle 31 is effectively restrained.

<EFFECTS OF CONSTRUCTION OF EMBODIMENT> In this embodiment, the increment amount CI of the counter C for estimating the particulate matter accumulation amount is acquired based on the particulate matter (smoke) amount and the nozzle temperature. Specifically, the particulate matter accumulation amount is acquired based on the number of operation cycles carried out in the first fuel injection mode, the particulate matter amount, and the nozzle temperature. This makes it possible to more accurately determine the amount of particulate matter that has accumulated in and around the second injection orifices 31c. That is, according to this embodiment, the fuel injection control in the engine equipped with the so-called variable injection orifices nozzle type fuel injection device 3 may be more appropriately performed.

In this embodiment, if a high-temperature state, in which the nozzle temperature is higher than or equal to a predetermined level, has continued for a predetermined time or longer, an operation that the nozzle temperature declines is performed. This effectively reduces the fixation of deposit to the distal end portion of the nozzle 31 and the acceleration of abrasion of the distal end portion of the nozzle 31. Therefore, the fuel injection control by the fuel injection device 3 can be more appropriately performed.

<EXAMPLE LISTING OF MODIFICATIONS> The foregoing embodiments and examples, as described above, are merely descriptions of representative embodiments of the invention that the present applicant considers to be the best mode at the time of filing this patent application. Therefore, the invention is not limited at all by the foregoing embodiments.

However, the foregoing embodiments may be modified in various manners within such a range that the essential portion of the invention is not changed.

A few representative modifications will be described below. It goes without saying that the modifications of the embodiments are not limited to those listed below. Furthermore, a plurality of modifications may be appropriately applied in a composite fashion as long as there is no technical contradiction.

The invention (in particular, what is operatively and functionally expressed with regard to various component elements that constitute means for solving the task of the invention) should not be limitedly interpreted based on the description of the foregoing embodiments and the modifications below. Such limited interpretation unreasonably impairs the interest of the applicant (rushing to fail an application under the first-to-file system) while unreasonably benefiting imitators, and therefore should not be permitted.

(A) The engine control system 1 is applicable to gasoline engines, diesel engines, methanol engines, and other arbitrary types of engines. There is no particular limitation on the number of cylinders, or the type of cylinder arrangement (the in-line arrangement, the V-arrangement, the horizontally opposed arrangement).

(B) Instead of the load sensor 58, a throttle position sensor that outputs a signal according to the degree of opening of the throttle valve 44 may be used.

(C) As the present-operation fuel injection amount F in S405, a commanded fuel injection amount (obtained by correcting the requested fuel injection amount based on the output of the air-fuel ratio sensor, and the like) may be used instead of the requested fuel injection amount.

(D) The nozzle temperature Tnz may be a measured value based on the output of a temperature sensor or the like, instead of the estimated value obtained by using the operation condition and the map.

(E) In the case where the particulate matter amount Qp is acquired via the smoke sensor 53, the upstream-side pressure sensor 55 and the downstream-side pressure sensor 56 can be omitted in terms of the acquisition of the particulate matter amount Qp (these are used to monitor the state of clogging of the catalyst filter 47).

The smoke sensor 53 may be installed in the exhaust manifold 45 at a position furthest upstream in the flow direction of exhaust gas as mentioned in conjunction with the foregoing embodiments. However, the installation position of the smoke sensor 53 is not limited so. For example, the smoke sensor 53 may also be installed between the catalyst filter 47 and the turbine 48b of the turbocharger 48.

(F) Instead of the acquisition of the particulate matter amount Qp via the smoke sensor 53 in S420 (or the acquisition of signals that correspond to the particulate matter amount Qp), the estimation of the particulate matter amount Qp (or the generation of a signal that corresponds to the estimated value of the particulate matter amount Qp) may be performed.

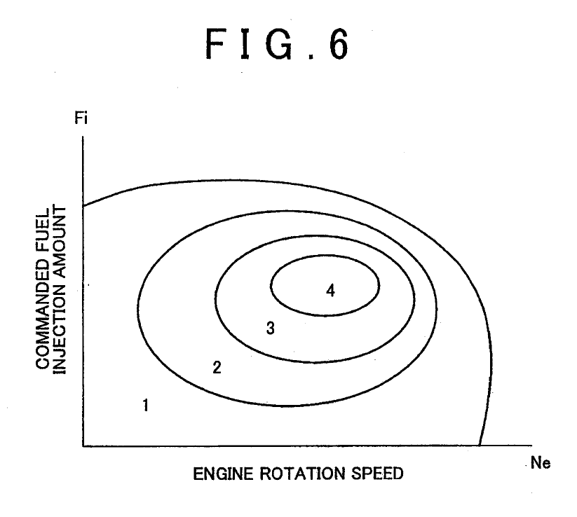

(F-1) For such estimation, for example, a soot map as shown in FIG. 6 may be used. This soot map is stored in the ROM 51c in order to estimate the state of collection of particulate matter s by the catalyst filter 47. This soot map is arranged so that the particulate matter amount Qp may be estimated based on the actual engine rotation speed Ne and the commanded fuel injection amount Fi. In this case, the CPU 51a and the ROM 51c function as a floating carbon particulate matter amount estimation portion in the invention.

With this construction, the smoke sensor 53 can be omitted, and it becomes unnecessary to use a dedicated map for estimating the particulate matter amount Qp, or the like. Hence, the device construction is simplified, and the processing burden on the CPU 51a may be reduced.

Incidentally, the soot map is based on the measured values of the particulate matter amount produced during the steady operation state of the engine. Therefore, during an actual operation (particularly, a transitional operation state), there may be a discrepancy between the target value of the intake air flow amount set via the accelerator pedal 61 and the measured value of the intake air flow amount Ga based on the output of the air flow meter 52.

Therefore, the particulate matter amount Qp obtained by the soot map may be corrected by taking the error in the intake air flow amount into consideration. Therefore, the estimation of the deposit amount can be more accurately performed. In this case, the CPU 51a and the ROM 51c function as a correction portion in the invention.

(F-2) The estimation of the particulate matter amount Qp may also be performed based on the outputs of the upstream-side pressure sensor 55 and the downstream-side pressure sensor 56 (the differential pressure across the catalyst filter 47). That is, the deposit accumulation amount may be estimated based on an estimated value of the soot clog amount on the catalyst filter 47. In this case, the CPU 51a functions as a floating carbon particulate matter amount estimation portion in the invention.

(G) The correction performed during the transitional operation by taking the error in the intake air flow amount into consideration may be suitably applied not only to the acquisition of the particulate matter amount Qp but also to other determination processes.

(H) A plurality of different means for acquiring the particulate matter amount Qp as described above may be simultaneously employed.

In such a construction, a plurality of instantaneous accumulation amounts of particulate matter, and a plurality of accumulation amounts of particulate matter are obtained based on a plurality of particulate matter amounts Qp. In this case, it is preferable that, of the plurality of instantaneous accumulation amounts or of the plurality of accumulation amounts, the largest amount be used to perform the fuel injection control.

Alternatively, the instantaneous accumulation amount of particulate matter or the accumulation amount of particulate matter may be obtained based on the largest one of a plurality of particulate matter amounts Qp.

According to this construction, the control of the fuel injection device 3 may be more appropriately performed. For example, the compulsory fuel injection control via the second injection orifices 31c may be performed at more appropriate timing. This effectively prevents the accumulation of sufficient amounts particulate matter that would completely obstruct the second injection orifices 31c.

(I) The timing of estimating the instantaneous accumulation amount of particulate matter and the accumulation amount of particulate matter is not necessarily made during each cycle (every predetermined crank angle), but may also be at a predetermined number of cycles (e.g., every number of cycles that corresponds to an integer multiple of the number of cylinders), or at predetermined intervals.

For example, if the particulate matter amount Qp is actually measured by using the smoke sensor 53, and the instantaneous accumulation amount of particulate matter and the accumulation amount of particulate matter are determined based on the actually measured particulate matter amount Qp, the determined value of the instantaneous attachment amount is considered to be relatively accurate. Hence, in this case, the instantaneous accumulation amount of particulate matter and the accumulation amount of particulate matter may be estimated during each cycle (every predetermined crank angle).

In contrast, for example, in the case where while the soot map is used, the correction of the intake air flow amount is not performed, or in the case where the differential pressure across the catalyst filter 47 is used, the estimation of the instantaneous accumulation amount of particulate matter and the accumulation amount of particulate matter at each predetermined number of cycles (e.g., every number of cycles that corresponds to an integer multiple of the number of cylinders) or at predetermined intervals (every predetermined crank angle) gives a higher accuracy.

(J) The determination of the accumulation amount of particulate mater in and around the first injection orifices 31b may be performed in the same manner. Specifically, if there is a large amount particulate matter, the accumulation of particulate matter in and around the first injection orifices 31b is promoted, which is substantially the same as in the case of the second injection orifices 31c described above. Therefore, the invention may also be favorably applied to a fuel injection device 3 equipped with nozzles 31 that do not have second injection orifices 31c.

(K) In the foregoing processes, the actual engine rotation speed Ne may also be used instead of the requested engine rotation speed N. Furthermore, the internal pressure Pcr of the common rail 32 may also be used as the fuel injection pressure P.

(L) As described above, the construction of the invention is applicable to various instances in the operation controls of the engine control system 1 (fuel injection device 3). Therefore, for example, the invention may be favorably applied not only in the case of compulsory injection of fuel as in the foregoing embodiments, but also when the correction of the fuel injection amount is performed (a correction amount for correcting the requested fuel injection amount and therefore obtaining a commanded fuel injection amount is obtained). The correction that the fuel injection amount is increased, the correction that the fuel injection pressure is increased, etc., may also be executed.

(M) Furthermore, among the elements that constitutes the means for solving the task of the invention, elements that are operatively or functionally expressed include not only the structures disclosed above in conjunction with the embodiments and modifications, but also any other structure that is able to realize the foregoing operation and function.

For example, various sensors in the system of the foregoing embodiments may be appropriately omitted, that is, replaced by the estimation by the CPU 51a, or replaced by sensors of a different construction, or may be constructed so that the output other than voltage (e.g., current, impedance, or numerical data) is generated.

1. A control device for an internal combustion engine that includes a fuel injection device that injects fuel through an injection orifice into a combustion chamber, the control device comprising:
a carbon particulate matter amount output portion that produces an output indicating a floating carbon particulate matter amount in a post-combustion gas discharged from the combustion chamber into an exhaust passageway; and
an accumulation amount output portion that produces an output indicating an accumulation amount of an extraneous matter in and around the injection orifices based on the output of the carbon particulate matter amount output portion.

2. The control device according to claim 1, wherein the carbon particulate matter amount output portion includes a floating carbon particulate matter amount sensor that is provided on the exhaust passageway.

3. The control device according to claim 1, wherein the carbon particulate matter amount output portion includes a floating carbon particulate matter amount estimation portion that outputs an estimated value of the floating carbon particulate matter amount based on an operation condition of the internal combustion engine.

4. The control device according to claim 3, wherein the floating carbon particulate matter amount estimation portion outputs the estimated value of the floating carbon particulate matter amount based on a signal that indicates a quantity of fuel injected into the internal combustion engine and a signal that indicates an engine rotation speed.

5. The control device according to claim 3, wherein the exhaust passageway is provided with: a filter that traps the floating carbon particulate matter; a first pressure sensor that is provided upstream from the filter and that produces an output that indicates pressure of the gas; and a second pressure sensor that is provided downstream from the filter and that produces an output that indicates the pressure of the gas, and wherein the floating carbon particulate matter amount estimation portion outputs the estimated value of the floating carbon particulate matter amount based on the output of the first pressure sensor and the output of the second pressure sensor.

6. The control device according to claim 3, further comprising:
a correction portion that corrects the estimated value based on a present intake air amount.

7. The control device according to claim 2, wherein the carbon particulate matter amount output portion produces a plurality of outputs that indicate the floating carbon particulate matter amount, and the accumulation amount output portion produces an output based on the output from the carbon particulate matter amount output portion that gives the largest value of the floating carbon particulate matter amount, or one of a plurality of values that indicate the accumulation amounts obtained based on the output from the carbon particulate matter amount output portion that gives the largest value of the accumulation amount.

8. The control device according to claim 1, wherein the accumulation amount output portion produces an output based on the temperature of a portion of the fuel injection device adjacent to the injection orifices.

9. The control device according to claim 1, wherein if the temperature of the portion of the fuel injection device adjacent to the injection orifices is equal to or higher than a predetermined temperature for at least a predetermined time, a control is executed to reduce the temperature of the portion of the fuel injection device adjacent to the injection orifices by to changing an operation state of the internal combustion engine.

10. The control device according to claim 1, wherein the fuel injection device has first injection orifices and second injection orifices, and selectively injects fuel through either the first injection orifices alone, or through both the first injection orifices and the second injection orifices, and wherein the accumulation amount output portion produces an output that indicates the accumulation amount of the extraneous matter in and around the second injection orifices.

11. The control device according to claim 1, wherein compulsory injection of fuel is performed in order to remove the extraneous matter in accordance with the output of the accumulation amount output portion.

12. The control device according to claim 1, wherein at least one of the fuel injection amount and the fuel injection pressure is corrected to remove the extraneous matter in accordance with the output of the accumulation amount output portion.

13. A control method for an internal combustion engine that includes a fuel injection device that injects fuel through an injection orifice into a combustion chamber, the control method comprising:
producing an output that indicates a floating carbon particulate matter amount in a post-combustion gas discharged from the combustion chamber into an exhaust passageway; and
producing an output that indicates an accumulation amount of an extraneous matter in and around the injection orifices based on the output that indicates the floating carbon particulate matter amount.
